(19) United States
(12) Patent Application Publication
(10) Pub. No.: US 2022/0417310 A1
(43) Pub. Date: Dec. 29, 2022

(54) System and Method for Providing Local Content

(71) Applicant: Radiant Communications Corporation, South Plainfield, NJ (US)

(72) Inventors: Eugene Thaw, Long Beach Township, NJ (US); Lyubomir Trayanov, Easton, PA (US); David V Jones, Horseshoe Bend, ID (US)

(21) Appl. No.: 17/850,989

(22) Filed: Jun. 27, 2022

Related U.S. Application Data
(60) Provisional application No. 63/215,398, filed on Jun. 25, 2021.

(51) Int. Cl. H04L 65/75; H04L 9/40; G06F 16/957; G06F 21/10

(52) U.S. Cl. CPC H04L 65/764; H04L 63/0236; G06F 16/9574; G06F 21/10

(57) ABSTRACT

A content delivery system adapted to provide access to local content is provided. In one embodiment, the system includes a stream director server and an encoder. The stream director server is adapted to receive a request for local content from a client, determine an identifier corresponding to the local content, and provide a redirect to the client based on the identifier. The encoder is adapted to receive a redirected request from the client and provide the local content to the client for presentation. A method of providing access to local content is also provided. The method includes receiving a request for local content from a client at a server; parsing client identifying data and content identifying data from the request; authenticating the request based at least in part on the client identifying data; and providing a redirect to the client for the requested content.

### CROSS-REFERENCE TO RELATED APPLICATIONS

This application claims the benefit of U.S. provisional application No. 63/215,398 entitled “System and Method for Providing Local Content” filed 25 Jun. 2021, which is hereby incorporated by reference as though fully set forth herein.

### BACKGROUND

### a. Field

The instant invention relates to a technology for inserting local content into a content streaming application.

### b. Background

Multi-Dwelling Units (MDUs), institutions, campuses, and other facilities can host a common content (e.g., cable) networks that also provide local content that may be displayed over the network. Traditionally, local content has been RF modulated and inserted in a system as one or more additional channels that may be decoded by a set-top box or other device for presentation. However, where content is delivered digitally, RF insertion is tough to achieve.

A content delivery system provides a distributed platform of servers that store copies of content for delivery to nearby users. The individual servers store copies of content that can be accessed without delays over longer network paths. The content delivery systems also include load balancers that receive requests for content and match those requests with content servers based on location and/or load to reduce latency.

### BRIEF SUMMARY

A content delivery system adapted to provide access to local content is provided. In one embodiment, the system includes a stream director server and an encoder. The stream director server is adapted to receive a request for local content from a client, determine an identifier (e.g., a URL) corresponding to the local content, and provide a redirect (e.g., a 302 redirect) to the client based on the identifier. The stream director server can also receive content acquisition request over http containing account number/secret key, geolocation data or hardware identifier as source IP or MAC address. Based on a set redirection rule that uses on or combination of the parameters received content acquisition request the stream director replies with number of content URLs and metadata sets (program name, description language, type and icon) that a distributed to that client. The encoder is adapted to receive a redirected request from the client and provide the local content to the client for presentation.

In one embodiment, a client is provided in communication with the stream director server. The client may reside on a computer, such as but not limited to, a set top box or other computer adapted for receiving streamed content and displaying it for one or more users.

In one embodiment, the stream director server determines the identifier corresponding to the local content via one or more database (account number/secret key, geolocation data, source IP and MAC address).

In one embodiment, the stream director server is adapted to authenticate the request, such as via an IP address received with the request from the client.

In one embodiment, the stream director server is adapted to determine whether the IP address is within a range of authorized IP addresses and/or via a geolocation of the client.

In one embodiment, the stream director server is adapted to encrypt the session with the client.

In one embodiment, the encoder is an origin server.

In another embodiment, a method of providing access to local content is also provided. The method includes receiving a request for local content from a client at a server; parsing client identifying data and content identifying data from the request; authenticating the request based at least in part on the client identifying data; and providing a redirect to the client for the requested content.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a block diagram showing an embodiment of a system for delivering local content in an over-the-top (OTT) streaming content delivery application.

FIG. 2A is a block diagram showing an embodiment of operations adapted to deliver local content in the OTT streaming content delivery application shown in FIG. 1.

FIG. 2B is a flow chart showing the operations shown in FIG. 2A.

FIG. 3 is a block diagram showing an example dashboard that shows set links, URLs, and their status in a table format.

FIG. 4 shows a grouping of clients into one or more groups and subgroups.

FIG. 5 shows an example of a video source list that may be used within the system.

FIG. 6 is a block diagram showing an example of a stream director and database relationship.

FIG. 7 is a block diagram showing an embodiment of a local webcasting system with an intelligent stream direction.

FIG. 8 is a block diagram showing an embodiment of a distributed webcasting system with an intelligent stream direction.

FIG. 9 is a block diagram showing an embodiment of a system for delivering local content in an over-the-top (OTT) streaming content delivery application.

FIG. 10 is a block diagram showing an embodiment of operations adapted to deliver local content in the OTT streaming content delivery application shown in FIG. 9.

FIG. 11 is a block diagram showing an example dashboard that shows set links URLs, and their status in a table format.

FIG. 12 shows an example program settings screen showing an example channel.

FIG. 13 is a block diagram showing an example of a stream director and database relationship.

### DETAILED DESCRIPTION

With the evolution of Cable access networks to highly segmented next generation access networks i.e. GPON or RemotePhy, and IP delivered services, new methods of local content access and publishing are needed. The new methods will allow managed properties, such as nursing homes, or managed gated communities to continue to offer local programming and informational channel services to their residents using Over The Top (OTT) delivery. Local MDU content services such as gate cameras, bulletin boards, educational programming, and local entertainment productions are typical examples.

Local Webcasting is the ability to publish locally generated content using the Internet as the distribution medium as opposed to traditional methods of local channel insertion. Local Webcasting uses Internet access to provide connectivity to users within a community. Local content can be accessed as a web service through access clients, e.g. computers, tablets, phones, or set top boxes with web browsing and DAS player capabilities.

As used in this application, local content includes MDU, campus, PEG, and LO content. A Multi-Dwelling Unit (MDU) may include any multi-dwelling living community, including one or more of the following: gated communities, apartment complexes, condominium complexes, resorts, elderly communities and care facilities. Campus content includes houses of worship, school or university campuses such as college campuses, military bases, and business complexes. Public, Educational, and Government (PEG) content includes public, educational, and governmental Access Channels including local government institutions, local school districts and local public access channels providing information. LO content includes public local access content, such as non-commercial mass media where the general public can create content video programming.

Local content includes character generated billboard information that may include picture slides and video; live video events from public spaces, including board meetings and public hearings, school activities like educational board meetings, student plays and sports; programming created by the members of the general public and public events; congregation services; and localized information and video services (public and business).

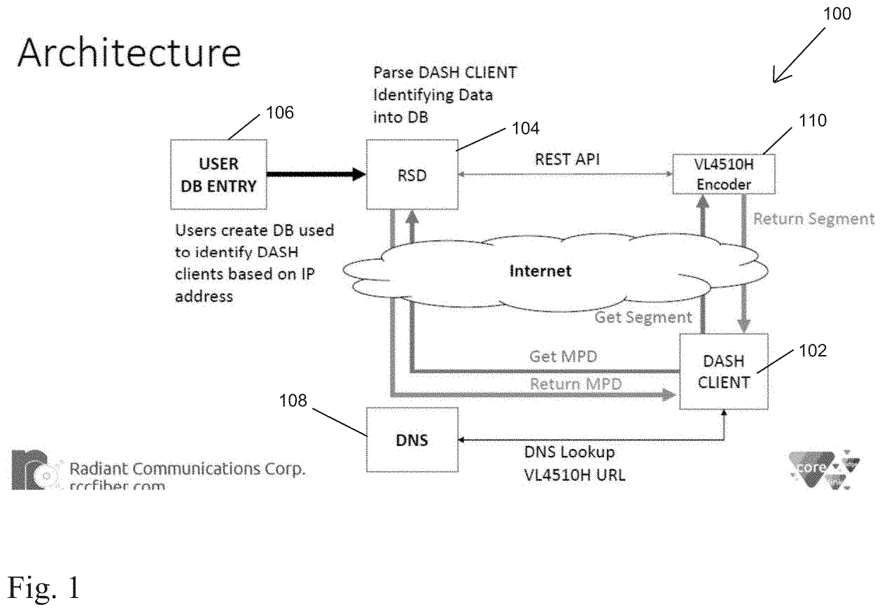

FIG. 1 is a block diagram showing an embodiment of a system 100 for delivering local content in an over-the-top (OTT) streaming content delivery application. In this embodiment, the system 100 includes a client 102 (e.g., a dynamic adaptive streaming over HTTP (DASH) client). The client 102 can reside on a computer, such as a set top box (STB) adapted to receive and decode digital television (DTV) signals. In other embodiments, the computer may comprise a desktop computer, a tablet computer, a mobile phone, or a set-top computer.

The computer runs or accesses a software application, such as a web application, a mobile application, or an over-the-top (OTT) application, including the client 102. The software application can include any executable logic that runs on the computer. A web application, for example, can include executable logic that runs in a network-based client or a network browser, whether based on a virtual machine, a script, or an extension, such as via a client-server architecture when processing is server-based and remote to the computer. A mobile application can include any executable logic that runs on a mobile device, such as a mobile phone or a tablet computer. An OTT application can include any executable logic that runs on a computer to provide a network-based content independent of a network operator, such as a multiple system operator. In an embodiment, the software application can be an overlap or a combination of at least two of the web application, the mobile application, and the OTT application.

The client 102 runs the software application, which outputs a request to play one or more local content. The request can be a message generated via a manual input, such as via a graphical user interface (GUI), or via the software application automatically, whether directly or indirectly. The request is communicated from the client 102 to a stream director (SD) server 104. The SD server 104 is adapted to process the request for processing upon receipt, such as in real-time. The content may include any type of content, such as but not limited to video content, image content, audio content, interactive content, video game content or the like. The content, for example, may include video content such as a local camera feed, local programming, instructional programming, or the like. Image content may include bulletin board type notices, maps, menus, activities, contact information, or the like.

The SD server 104 parses identifying data from the request and accesses a database 106 to retrieve a uniform resource locator (URL) corresponding to the requested content. Using this URL, the SD server 104 provides a redirect (e.g., a 302 redirect to the client 102) or URL list and programs metadata to access the requested content.

In one embodiment, the SD server 104 is further adapted to authenticate the request to restrict access to local content to an authorized user or client. The request, for example, may provide an Internet Protocol (IP) address, geolocation information, account number, secret key, MAC address or other authenticatable information. In one embodiment, the IP address is analyzed to determine if the IP address is within one or more authorized ranges of addresses to access the content. The SD server 104 may utilize SSL certificates and provide an encrypted session to prevent information pertaining to local content from being accessed by an unauthorized party or device. Where an unauthorized attempt to access the content is determined to have occurred, information about the attempt may be stored in the database 106 (or in another database or event log) and the session may be sent to a captive portal to prevent unauthorized access. Standard AES encryption as well as other types of encryption may also be used.

If the request is authenticated, the SD server 104 provides a redirect or URL list to the client 102. In one embodiment, the SD server 104 provides a URL as a 302 redirect to the client 102. In one embodiment, the SD server 104 provides a URL list and programs metadata to the client 102. The client 102 looks up the URL or URLs, such as in the domain name server (DNS) 108 to identify an IP address for an encoder 110 hosting the content. In this manner, the client 102 need not have a comprehensive library, map, listing, or the like for all the possible local content that may be provided via any number of systems. The SD server 104 and database 106 provide the information to enable the client 102 to access local content available for the system 100, and the client and set-top box on which it resides may be generic and adapted to operate on any number of other systems hosting their own local content.

For authentication, the request can contain request information for a location of the computer on which the client 102 resides, such as an IP address, MAC address, Account Number/Secret Key, a geolocation, a jurisdiction, a network location, a geofence, or a network type. The request can also contain request information for a device type of the computer operated by the user, such as a desktop computer, a mobile device, or a set-top computer. The request can also contain request information for an operating system (OS) type of the computer operated by the user, such as Android® or iOS®.

In one embodiment, the client 102 sends a request for the local content to the encoder 110 using the IP address retrieved from the DNS 108. The encoder 110 provides the content to the client 102 for streaming or other presentation to a user. In one embodiment, the encoder includes an origin server.

Via REST API the SD server 104 can gather stats from encoder 110, in addition user can change settings/configure remote encoder 110 from SD server 104. An automated workflow for batch settings change or system upgrade for multiple encoders 110 can be provided. With REST API SD server 104 can become a centralized manager for all remote encoders.

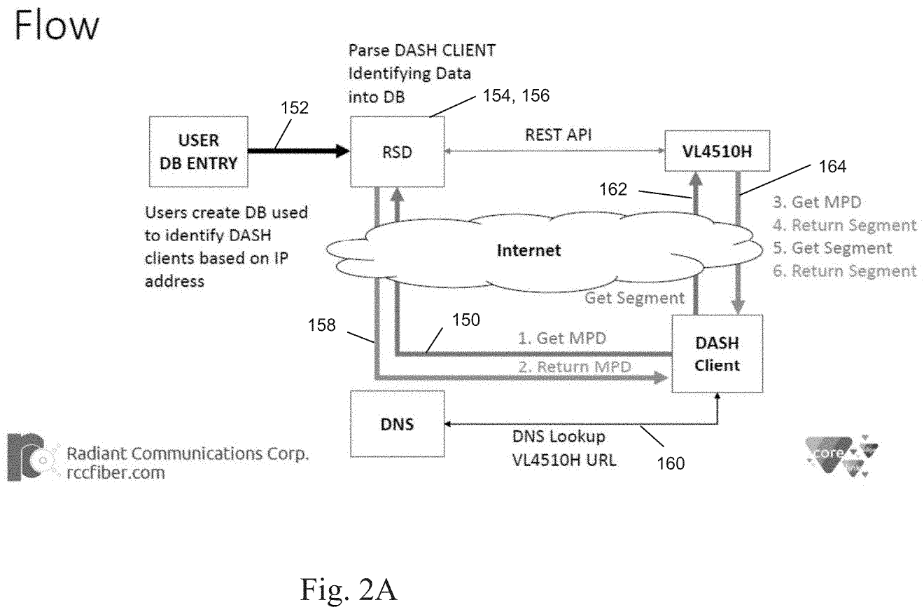

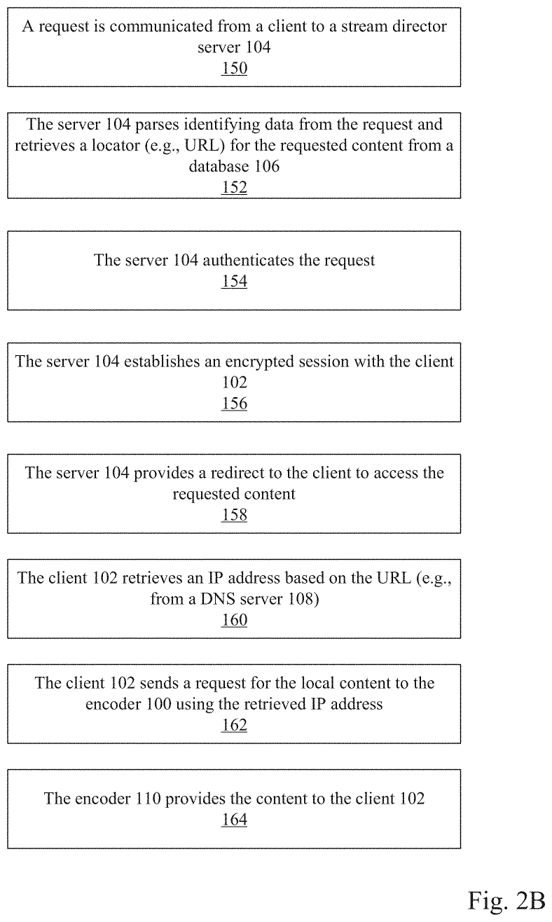

FIG. 2A is a block diagram showing an embodiment of operations adapted to deliver local content in the OTT streaming content delivery application shown in FIG. 1. FIG. 2B is a flow chart showing the operations shown in FIG. 2A. The request can be a message generated via a manual input, such as via a graphical user interface (GUI), or via the software application automatically, whether directly or indirectly. In operation 150, a request (e.g., an HTTP request) is communicated from the client 102 to a stream director (SD) server 104. The SD server 104 processes the request upon receipt, such as in real-time.

The SD server 104 parses identifying data from the request and accesses a database 106 to retrieve a uniform resource locator (URL) or other locator corresponding to the requested content in operation 152 and can authenticate the request in operation 154. As described above, the authentication can be determined based on one or more identifying data received with the request. Account number/Secret Key, MAC, IP address and/or a geolocation tag may be reviewed to determine whether the client 102 is authorized to access the local content. Where an MDU or other local system has a range of IP addresses, for example, the IP address received with the request from the client can be reviewed to see if it is within the range of authorized IP addresses. The server 104 can further establish an encrypted session with the client 102, such as via SSL certificates in operation 156 to prevent the content from being accessed inappropriately.

Using this URL, the SD server 104 provides a redirect (e.g., a 302 redirect) or URL list to the client 102 to access the requested content in operation 158.

The client 102 looks up the URL, such as in the domain name server (DNS) 108, to identify an IP address for an encoder 110 hosting the content in operation 160.

The client 102 sends a request for the local content to the encoder 110 using the IP address retrieved from the DNS 108 in operation 162. The encoder 110 provides the content to the client 102 for streaming or other presentation to a user in operation 164.

In one embodiment, a DASH Client starts by downloading a manifest describing the media and its media segments, followed by the client downloading a series of these segments. The initial http get for manifest (dash mpd file) is sent to RSD server app (Radiant Stream Director) via set number of URLs. DASH Clients are then cross referenced to specific MPD file from specific Source DASH Encoder (either VL4500 or ELLVIS9000) based on IP address range of the client, List of Clients, Sources and LINKS added to a database (e.g., a mongo db). Changes to source encoder settings can be updated in the DB and then applied to single or multiple encoders, such as via a rest API.

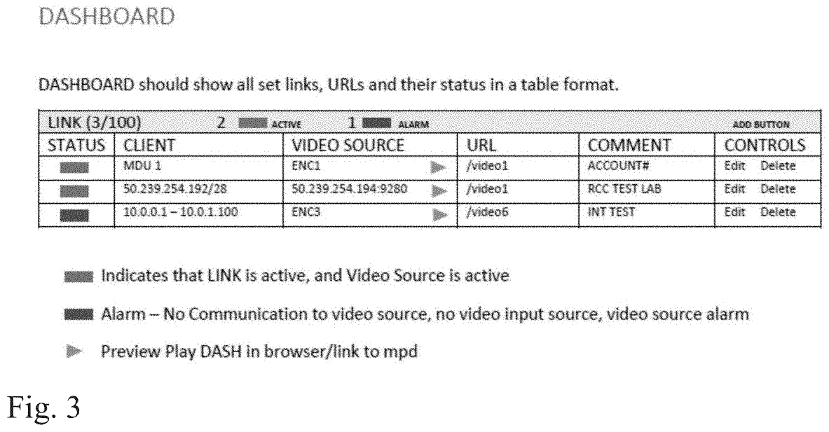

FIG. 3 shows an example dashboard that shows set links, URLs, and their status in a table format. In this embodiment, the table indicates whether a link or video source is active or inactive. The table may further provide an alarm that may indicate a condition such as no communication to a video or other data source, no input video or other data source, or a video or other data source alarm. A preview play link is also provided in this embodiment. The table also provides an ability to set multiple URLs for access to content, set multiple links for deletion or editing of a URL or video or other data source. In this particular embodiment, a client can be used in only one link (although any number of links may be used), and a video or other data source can be used in multiple links.

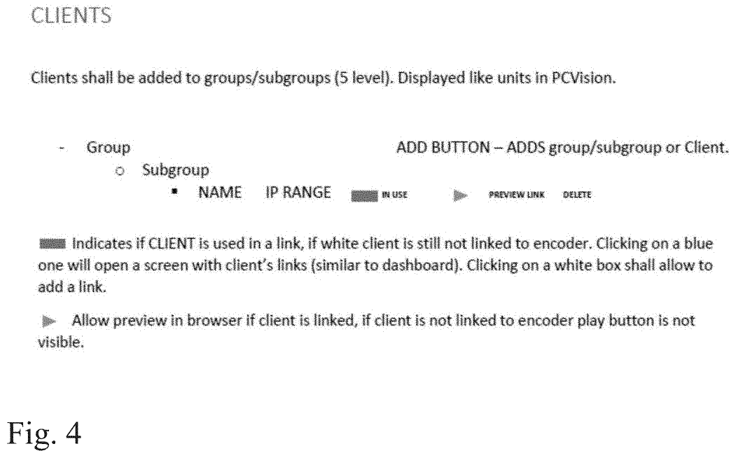

FIG. 4 shows a grouping of clients into one or more groups and subgroups. In this particular embodiment, the grouping includes five levels of groups/subgroups, although any number of levels is possible. Selecting (e.g., by clicking on) a group can allow editing of the group name. Selecting the Name or IP Range allows editing of attributes associated with the client record. The system can also provide the ability to select a plurality of clients to delete or edit one or more attribute of the group. Further, the system can allow linking multiple clients to a single encoder.

The client grouping in this embodiment also indicates if a client is in use in a link or if the client is not linked to an encoder. The grouping may also provide an ability to access further information associated with a client such as opening a screen with a client's links or other activity (similar to the dashboard discussed with reference to FIG. 3). One or more links can also be added by selecting an option.

If a client is linked, the system can provide the ability to play a preview of content (e.g., in a browser). If the client is not linked, the option may not be selectable.

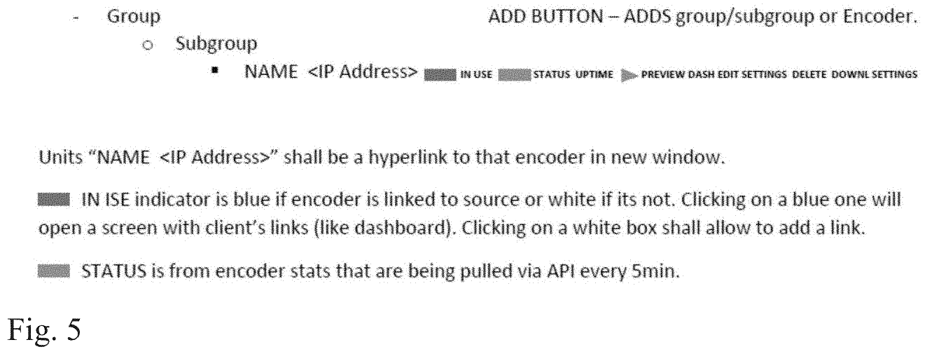

FIG. 5 shows an example of a video source list that may be used within the system. In this embodiment, video sources/encoders can be added to groups/subgroups, such as described above with respect to FIG. 3. The source list provides the ability to select multiple encoders (e.g., individual, group, or subgroup) to allow editing such as batch deleting or editing. FIG. 5 also shows an overview of the encoders' status, how many are linked, alarm status, idle, running, or no video input. The entry for NAME <IP Address> provides a hyperlink to that encoder such as in a new window. An IN ISE indicator displays whether the encoder is linked to a source or not. When the encoder is linked, an option is provided to open a display with the client's link(s), and a further option may be provided to add one or more links.

A STATUS from the encoder may be pushed, pulled or otherwise accessed on a schedule or upon request (e.g., by an API every 5 minutes). Example status indicators include connectivity, no connectivity, idle, video/data input available, no video/data input, alarm, running, etc. FIG. 5 further shows examples of settings for video, audio, DASH, and system.

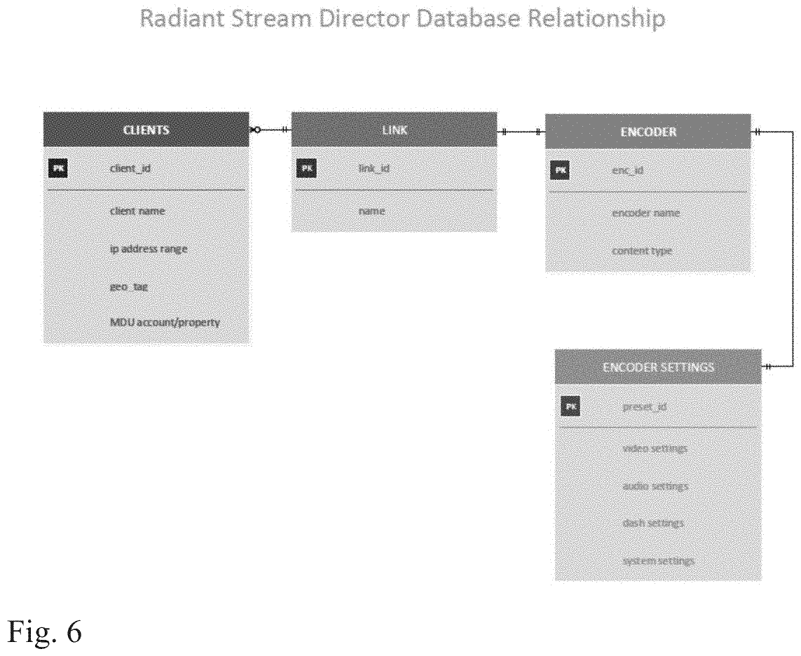

FIG. 6 shows an example of a stream director and database relationship. In this embodiment, clients are identified by a client ID. The client ID corresponds to a client name, IP address, a geo_tag, and an MDU account/property identifier. Links are identified by link ID and link name. Encoders are identified by an encoder ID, an encoder name, and an encoder type. In one example, encoder settings can be identified by a preset ID. The preset ID in this example can also be associated with settings, such as video settings, audio settings, dash settings, and system settings.

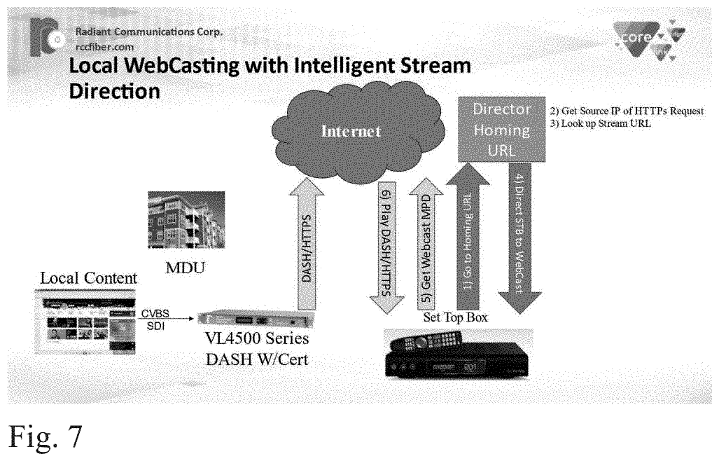

FIG. 7 shows an embodiment of a local webcasting system with an intelligent stream direction. Local webcasting additions can come with the challenge of how to map many local content sources (e.g., MDU or community channels) to the one or more top box channel maps. In a typical system, if a local web cast is mapped to a virtual channel on set top boxes, every local group (e.g., MDU) would then require its own channel map. In this embodiment, however, a Director Server is provided that publishes a homing URL to the web. The set top boxes in multiple MDU communities or other local content providers have the local channel mapped to the Homing URL of the server. The server intelligently directs the set top or smart TV client to the proper content stream of home community or MDU. In this particular embodiment, the steps are the following:
Set Top Box Client Goes to Homing URL (HTTPS Get)
Director Server Parses Source IP address of request
Director Server looks up URL of Local Content (e.g., WebCaster Target URL) based on Source IP
Director sends Set Top Box Client to Local Content (e.g., Webcaster for stream manifest (MPD))
Set Top Box Receives the Content (e.g., webcast)

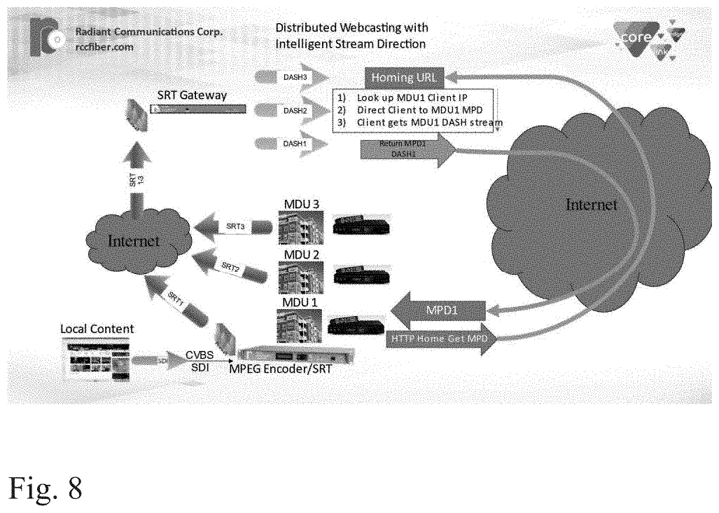

FIG. 8 shows an embodiment of a distributed webcasting system with an intelligent stream direction. In this embodiment, backhauling local (e.g., MDU) content to the Data Center and publishing it OTT to the Web imposes the same channel map management challenge as Local Webcasting does. In this embodiment, this can be solved by adding decision making Director logic to the ELLVIS SRT gateway. Now the gateway will direct the local (e.g., MDU) clients to the target URL of the proper OTT stream. Every local virtual channel is mapped to the Homing URL of the SRT Gateway. When a local Client requests a stream, the Gateway examines the incoming HTTP request and retrieves the client's source IP address. From the unique IP address of the client, the gateway cross references the Target URL of the OTT stream that client is entitled to view and directs the client to the proper Target URL URL. The client then begins receiving via HTTPS the content stream.

The Director software can get unique client data to use when cross referencing WebCasts. For example, an IP location database for all local providers (e.g., MDUs) can be created through manual entry or by parsing data from DHCP servers. A subnet range or firewall CPE IP address can be used for this purpose. A geolocation service can also be used to build a database to cross reference IP addresses to physical account locations.

Webcasting of Locally Originated MDU content provides a way to make the content accessible to local (e.g., MDU) clients without consuming linear service transmission resources. Distributed Webcasting adds elements of control and security to the service. Using Intelligent Stream Direction, simplification of channel mapping of local content (e.g., MDU virtual channels) can be achieved by using a common Gateway Homing URL for every local content provider (e.g., MDU). Intelligent Stream Direction can be used to direct proper digital signage to departments within a campus, direct targeted weather forecasts to specific locations, or to schedule content workflows that originate from different physical locations around the globe.

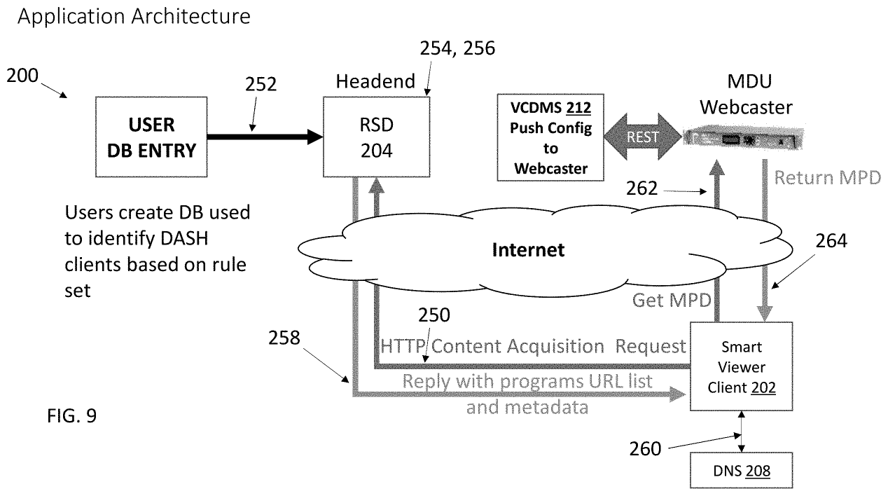

FIG. 9 is a block diagram showing another embodiment of a system 200 for delivering local content in an over-the-top (OTT) streaming content delivery application. In this embodiment, the system 200 includes a client 202 (e.g., a Smart Viewer, such as but not limited to a set-top box, portable computing device, smartphone, tablet, PC, laptop, or dynamic adaptive streaming over HTTP (DASH) client). In one embodiment, the client 202 resides on a computer, such as a set top box (STB) adapted to receive and decode digital television (DTV) signals. In other embodiments, the computer may comprise a smart viewer, a desktop computer, a tablet computer, a mobile phone, or a set-top computer.

The computer includes a processor adapted to run or access a software application, such as a web application, a mobile application, or an over-the-top (OTT) application, including the client 202. The software application can include any executable logic that runs on the computer. A web application, for example, can include executable logic that runs in a network-based client or a network browser, whether based on a virtual machine, a script, or an extension, such as via a client-server architecture when processing is server-based and remote to the computer. A mobile application can include any executable logic that runs on a mobile device, such as a mobile phone or a tablet computer. An OTT application can include any executable logic that runs on a computer to provide a network-based content independent of a network operator, such as a multiple system operator. In an embodiment, the software application can be an overlap or a combination of at least two of the web applications, the mobile application, and the OTT application.

The client 202 runs the software application, which outputs a request to play one or more local content. The request can be a message generated via a manual input, such as via a graphical user interface (GUI), or via the software application automatically, whether directly or indirectly. The request is communicated from the client 202 to a stream director (SD) server 204. The SD server 204 is adapted to process the request for processing upon receipt, such as in real-time. The content may include any type of content, such as but not limited to video content, image content, audio content, interactive content, video game content or the like. The content, for example, may include video content such as a local camera feed, local programming, instructional programming, or the like. Image content may include bulletin board type notices, maps, menus, activities, contact information, or the like.

The SD server 204 parses identifying data from the request and accesses a database 206 to retrieve a uniform resource locator (URL) corresponding to the requested content. Using this URL, the SD server 204 provides a redirect (e.g., a 302 redirect to the client 102) or URL list and programs metadata to access the requested content.

In one embodiment, the SD server 204 is further adapted to authenticate the request to restrict access to local content to an authorized user or client. The request, for example, may provide an Internet Protocol (IP) address, geolocation information, account number, secret key, MAC address or other authenticatable information. In one embodiment, the IP address is analyzed to determine if the IP address is within one or more authorized ranges of addresses to access the content. The SD server 204 may utilize SSL certificates and provide an encrypted session to prevent information pertaining to local content from being accessed by an unauthorized party or device. Where an unauthorized attempt to access the content is determined to have occurred, information about the attempt may be stored in the database 206 (or in another database or event log) and the session may be sent to a captive portal to prevent unauthorized access. Standard AES encryption as well as other types of encryption may also be used.

If the request is authenticated, the SD server 204 provides a redirect or URL list to the client 202. In one embodiment, the SD server 204 provides a URL as a 302 redirect to the client 202. In one embodiment, the SD server 204 provides a URL list and programs metadata to the client 202. The client 202 looks up the URL or URLs, such as in the domain name server (DNS) 208 to identify an IP address for an encoder 210 hosting the content. In this manner, the client 202 need not have a comprehensive library, map, listing, or the like for all the possible local content that may be provided via any number of systems. The SD server 204 and database 206 provide the information to enable the client 202 to access local content available for the system 200, and the client and set-top box on which it resides may be generic and adapted to operate on any number of other systems hosting their own local content.

For authentication, the request can contain request information for a location of the computer on which the client 202 resides, such as an IP address, MAC address, Account Number/Secret Key, a geolocation, a jurisdiction, a network location, a geofence, or a network type. The request can also contain request information for a device type of the computer operated by the user, such as a desktop computer, a mobile device, or a set-top computer. The request can also contain request information for an operating system (OS) type of the computer operated by the user, such as Android® or iOS®.

In one embodiment, the client 202 sends a request for the local content to the encoder 210 using the IP address retrieved from the DNS 208. The encoder 210 provides the content to the client 202 for streaming or other presentation to a user. In one embodiment, the encoder includes an origin server.

In this embodiment, a Video Content Distribution System (VCDMS) 212 is provided to provide operations, administration, maintenance, and provisioning of devices within the system. The VCDMS 212, for example, can gather stats from encoder/webcaster 210, in addition user can change settings/configure remote encoder/webcaster 210 from SD server 204. An automated workflow for batch settings change or system upgrade for multiple encoders/webcasters 210 can be provided. With REST API SD the VDCMS 210 can become a centralized manager for all remote webcasters/encoders.

The VCDMS 212, for example, may be configured to provide one or more of the following:
an element management system for video delivery networks,
addressability by device or group,
add, remove, or edit of single or multiple devices
control of remote encoders, decoders and media gateways,
batch firmware upgrade of remote devices,
device monitoring and event logging including security audit reports,
predictive maintenance with auto switchover to redundant gateway and backup,
predictive maintenance with continuous validation of encoder configuration and state,
auto discovery and configuration of new local or remote encoders, and
centralized control.

In particular, the provision of predictive maintenance with auto switchover to redundant gateway and backup, predictive maintenance with continuous validation of encoder configuration and state, and/or auto discovery and configuration of new local or remote encoders, provide improved installation, deployment, and reduced downtime of the local insertion system.

The SD insertion system for local content such as MDU, LO, and PEG programs also provide one or more of the following advantages:
Number of channels delivered to a community is not a concern for the MSO in terms of freeing additional RF space and bandwidth;
There is no need to create a local channel map on the DAC side (digital Accounting Software on the MSO side, usually very pricey task);
Remote unit installation and setup complexity is reduced without requiring cutting or splicing into cable or fiber plants (e.g., due to internet-based transport and communications);
Can allow installation to be performed by the end user: unpack, power up and connect to the internet; and
Each remote encoder is installed, serviced, and monitored automatically by a VCDMS management system ensuring reduced system/channel downtime.

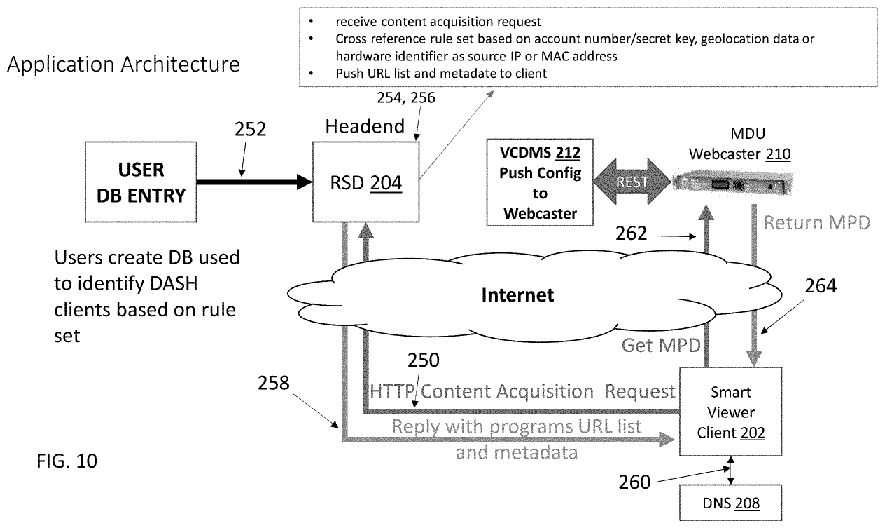

FIG. 10 is a block diagram showing an embodiment of operations adapted to deliver local content in the OTT streaming content delivery application shown in FIG. 9. The request can be a message generated via a manual input, such as via a graphical user interface (GUI), or via the software application automatically, whether directly or indirectly. In operation 250, a request (e.g., an HTTP request) is communicated from the client 202 to a stream director (SD) server 204. The SD server 204 processes the request upon receipt, such as in real-time.

The SD server 204 parses identifying data from the request and accesses a database 206 to retrieve a uniform resource locator (URL) or other locator corresponding to the requested content in operation 252 and can authenticate the request in operation 254. As described above, the authentication can be determined based on one or more identifying data received with the request. Account number/Secret Key, MAC, IP address and/or a geolocation tag may be reviewed to determine whether the client 202 is authorized to access the local content. Where an MDU or other local system has a range of IP addresses, for example, the IP address received with the request from the client can be reviewed to see if it is within the range of authorized IP addresses. The server 204 can further establish an encrypted session with the client 202, such as via SSL certificates in operation 126 to prevent the content from being accessed inappropriately.

Using this URL, the SD server 204 provides a redirect (e.g., a 302 redirect) or URL list to the client 202 to access the requested content in operation 258.

The client 202 looks up the URL, such as in the domain name server (DNS) 208, to identify an IP address for an encoder 210 hosting the content in operation 260.

The client 202 sends a request for the local content to the encoder 210 using the retrieved IP address in operation 262. The encoder 210 provides the content to the client 202 for streaming or other presentation to a user in operation 264.

In one embodiment, a DASH Client starts by downloading a manifest describing the media and its media segments, followed by the client downloading a series of these segments. The initial http get for manifest (dash mpd file) is sent to SD server app (Stream Director) via set number of URLs. DASH Clients are then cross referenced to specific MPD file from specific Source DASH Encoder (either VL4500 or ELLVIS9000) based on IP address range of the client, List of Clients, Sources and LINKS added to a database (e.g., a mongo db). Changes to source encoder settings can be updated in the DB and then applied to single or multiple encoders, such as via a rest API.

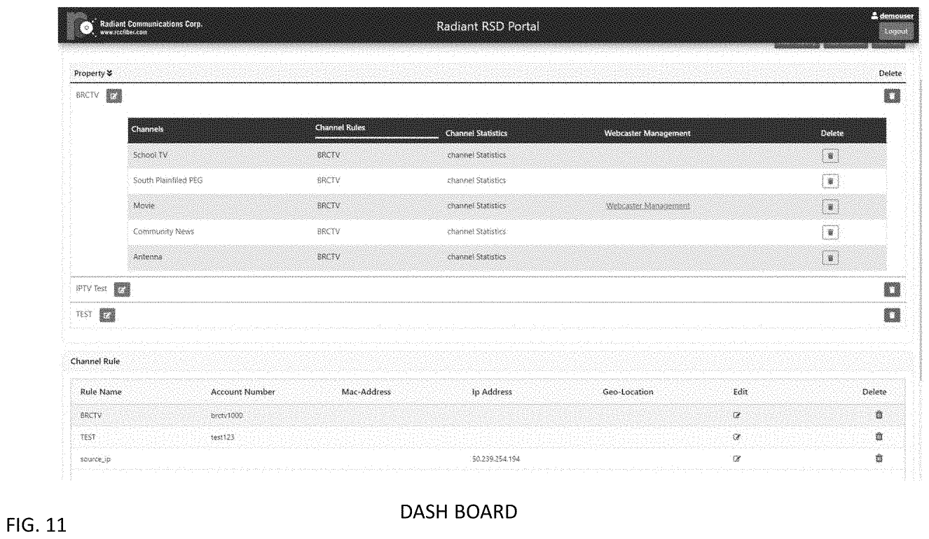

FIG. 11 shows an example dashboard that shows set links, URLs, and their status in a table format. In this embodiment, the table indicates whether a link or video source is active or inactive. The table may further provide an alarm that may indicate a condition such as no communication to a video or other data source, no input video or other data source, or a video or other data source alarm. A preview play link is also provided in this embodiment. The table also provides an ability to set multiple URLs for access to content, set multiple links for deletion or editing of a URL or video or other data source. In this particular embodiment, a client can be used in only one link (although any number of links may be used), and a video or other data source can be used in multiple links.

An example of a URL list response from a player dashboard is the following:

```
{
  “_id”: “62711ade4c736ffbe89815ed”,
  “program”: [ ],
  “videoSource”: [
    “billboard”,
    “https://rsd.rccfiber.com/customer-portal/#/view/629f94b7557abe03494f9049”
  ],
  “PropertyType”: [
    {
      “value”: “BRCTV”,
      “label”: “BRCTV”,
      “PropertyId”: “626bd64bfdb4a228e13e462d”,
      “ChannelRulesId”: “627a7560b559033d7fcb07fb”,
      “ChannelRulesName”: “BRCTV”
    }
  ],
  “channelName”: “Community News”,
  “channelDescription”: “Demo Bulletin Board\nComon Area Programing”,
  “channel_category”: “Bulletin Board”,
  “channel_language”: “English”,
  “programIcon”: “data:image/jpeg;
“UserId”: “623b20e46c80f5ffd7690d7b”,
  “createdAt”: “2022-05-03T12:06:54.392Z”,
  “updatedAt”: “2022-06-16T03:04:03.543Z”,
  “_v”: 0,
  “ChannelRulesName”: “BRCTV”,
  “RuleType”: {
    “AccountNumber”: “brctv”
  },
  “ChannelRulesId”: “627a7560b559033d7fcb07fb”
  }
```

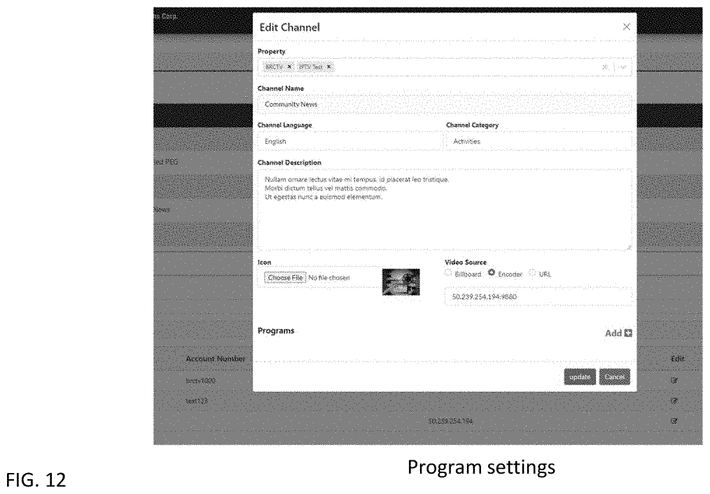

FIG. 12 shows an example program settings screen showing an example channel. In this example, the channel may be edited, displays metadata related to the channel, such as the channel name, a channel icon, and the like. The program settings screen in this example also enables assigning the channel to one or more rules.

An example of a parsed json data for the program settings screen shown in FIG. 12 is the following:

```
{
  “_id”: “62711ade4c736ffbe89815ed,”
  “program”: [ ],
  “videoSource”: [
    “billboard”,
    “https://rsd.rccfiber.com/customer-portal/#/view/629f94b7557abe03494f9049”
  ],
  “PropertyType”: [
    {
      “value”: “BRCTV”,
      “label”: “BRCTV”,
      “PropertyId”: “626bd64bfdb4a228e13e462d”,
      “ChannelRulesId”: “627a7560b559033d7fcb07fb”,
      “ChannelRulesName”: “BRCTV”
    }
  ],
  “channelName”: “Community News”,
  “channelDescription”: “Demo Bulletin Board\nComon Area Programing”,
  “channel_category”: “Bulletin Board”,
  “channel_language”: “English”,
  “programIcon”: “data:image/jpeg;
“UserId”: “623b20e46c80f5ffd7690d7b”,
  “createdAt”: “2022-05-03T12:06:54.392Z”,
  “updatedAt”: “2022-06-16T03:04:03.543Z”,
  “_v”: 0,
  “ChannelRulesName”: “BRCTV”,
  “RuleType”: {
    “AccountNumber”: “brctv”
  },
  “ChannelRulesId”: “627a7560b559033d7fcb07fb”
  }
```

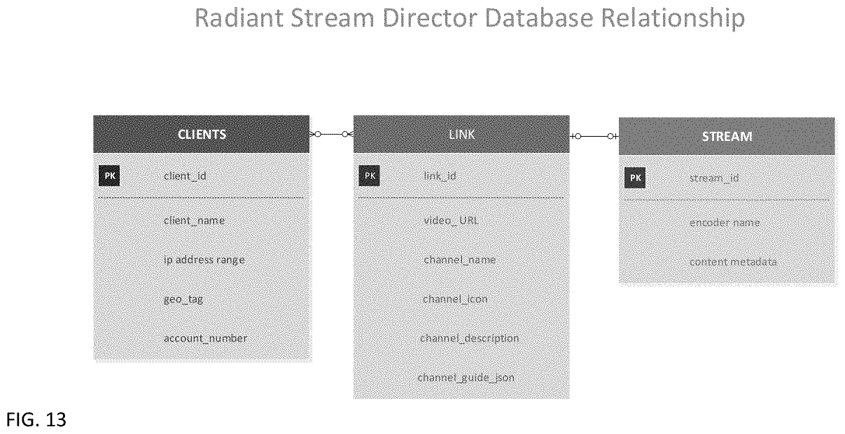

FIG. 13 shows another example of a stream director and database relationship. In this embodiment, clients are identified by a client ID. The client ID corresponds to a client name, IP address, a geo tag, and an MDU account/property identifier. Links are identified by link ID and link name. Encoders are identified by an encoder ID, an encoder name, and an encoder type

Features described with respect to certain embodiments may be combined and sub-combined in and/or with various other embodiments. Also, different aspects and/or elements of embodiments, as disclosed herein, may be combined and sub-combined in a similar manner as well. Further, some embodiments, whether individually and/or collectively, may be components of a larger system, wherein other procedures may take precedence over and/or otherwise modify their application. Additionally, a number of steps may be required before, after, and/or concurrently with embodiments, as disclosed herein. Note that any and/or all methods and/or processes, at least as disclosed herein, can be at least partially performed via at least one entity in any manner.

Although implementations have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

1. A content delivery system adapted to provide access to local content, the system comprising:
a stream director server adapted to receive a request for local content from a client, determine an identifier corresponding to the local content, and provide a redirect to the client based on the identifier; and
an encoder adapted to receive a redirected request from the client and provide the local content to the client for presentation.

2. The system of claim 1, wherein the client resides on a set-top box.

3. The system of claim 1, wherein the stream director server determines the identifier corresponding to the local content via a database.

4. The system of claim 3, wherein the identifier comprises a URL.

5. The system of claim 1, wherein the stream director server is adapted to authenticate the request.

6. The system of claim 5, wherein the stream director server is adapted to authenticate the request via an IP address received with the request from the client.

7. The system of claim 6, wherein the stream director server is adapted to determine whether the IP address is within a range of authorized IP addresses.

8. The system of claim 5, wherein the stream director server is adapted to authenticate the request via a geolocation of the client.

9. The system of claim 1, wherein the redirect comprises a 302 redirect.

10. The system of claim 1, wherein the redirect comprises a redirect via a DNS server.

11. The system of claim 1, wherein the stream director server is adapted to encrypt a session with the client.

12. The system of claim 1, wherein the encoder comprises an origin server.

13. A method of providing access to local content comprising:
receiving a request for local content from a client at a server;
parsing client identifying data and content identifying data from the request;
authenticating the request based at least in part on the client identifying data; and
providing a redirect to the client for the requested content.

14. The method of claim 13 wherein the server establishes an encrypted session with a client.

15. The method of claim 13 wherein the redirect comprises a 302 redirect.

16. The method of claim 13 wherein the redirect comprises a URL.

17. The method of claim 16 wherein the client retrieves an IP address based on the URL from a domain name server (DNS).

18. The method of claim 17 wherein the client receives the content from an encoder via the IP address.
